(19) United States
(12) Patent Application Publication
(10) Pub. No.: US 2006/0229964 A1
(43) Pub. Date: Oct. 12, 2006

(54) Personal pension system and business method

(76) Inventor: Fred Fox, Norcross, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/251,030

(22) Filed: Oct. 14, 2005

Related U.S. Application Data
(60) Provisional application No. 60/594,423, filed on Apr. 6, 2005.

(51) Int. Cl. G06Q 40/00

(52) U.S. Cl. 705/35

(57) ABSTRACT

A system and method of managing monetary contributions for a deferred savings objective such as, for exemplary purposes only, funding college, wedding or marriage, retirement, or any other large expense expected to occur years in the future, wherein a consumer makes contributions into the deferred savings system, wherein the process of the deferred savings method is not tied to any particular employer or employment status, wherein principal contributions are guaranteed after a minimum holding period, and wherein pre-event or pre-retirement withdrawals are restricted.

### CROSS-REFERENCE TO RELATED APPLICATION

To the full extent permitted by law, the present Non-Provisional Patent Application claims priority to and the benefit of United States Provisional patent application entitled “Personal Pension,” filed on Apr. 6, 2005, having assigned Ser. No. 60/594,423.

### FIELD OF THE INVENTION

The present invention relates generally to financial planning processes, and more particularly, to a personal pension system and method, wherein pre-retirement principal is guaranteed, wherein annuity conversion options are available upon retirement, wherein pre-retirement withdrawals are restricted, wherein beneficiaries are virtually unrestricted, wherein professional management is provided, wherein individual access and supervision is facilitated via a global networking system such as the Internet, and wherein complete independence from employer is enabled.

### BACKGROUND OF THE INVENTION

50 years ago people expected to die soon after age 65. They generally had a strong pension, public or private, in addition to their Social Security. Today's retirees expect to live approximately 15-25 years after age 65 and generally have a strong pension, public or private, in addition to Social Security. 25 years from now retirees can expect to live 20-30 years after age 65. Some will have a government pension, few will have a private pension, and Social Security benefits may be reduced. 50 years from now retirees can expect to live 25-35 years after retirement. Few will have either a public or private pension. The value of their Social Security benefits is in question, wherein the Social Security Administration trust fund is currently trillions of dollars under-funded in relation to promised benefits.

Whether intended to supplement or to act as an alternative to Social Security, a wide variety of retirement plans have been designed, both qualified and nonqualified. Participation of both employers and employees in qualified plans, such as defined benefit or defined contribution plans, is rewarded by tax incentives from the Internal Revenue Service (IRS). Such plans can be entirely dependent upon contributions from the employer, such as in the case of a defined benefit plan, wherein an employer provides an employee with a lifetime monthly pension upon retirement, based upon the number of employment years and level of compensation. One disadvantage of this type of plan is the excessive dependence upon the financial viability of the employer, wherein improper management can result in a catastrophic loss of retirement benefits.

Alternatively, qualified plans can be sponsored by both employers and employees, such as in the case of a defined contribution plan, for example, a 401(k), wherein funds are managed by third-party professionals. One disadvantage of this type of plan is that ultimate retirement benefit distribution is wholly dependent upon paid-in contribution and investment returns, and is thus uncertain.

Essentially free from IRS regulation, however, nonqualified plans are able to offer more unlimited options. Examples include deferred compensation, typically offering an agreed upon interest rate to be paid by the employer, split dollar life insurance, offering an agreed upon death benefit to be shared by the employer, and supplemental executive retirement plans, offering pension-type recognition for compensation above traditional pension maximums. Each is not constrained by income limitations, is generally managed and sponsored by an employer, and is funded by payroll deferrals. Each has beneficial characteristics, however, is disadvantageously tied to a given employer.

Other sources for retirement funding have become necessary, even for those with employer plans. Most individuals now move between several major employers, or even several careers, throughout their earning years. Many do not remain with one employer long enough for pension benefits to vest and/or are faced with other non-portable investment limitations and loss.

Therefore, it is readily apparent that there is a need for a financial planning process with employer independence, that is, for a personal pension system and method with guaranteed pre-retirement principal protection, wherein retirement funding tasks are segregated among parties best suited to each task, and participants are in control of their contribution amounts, contribution dates, benefit commencement date and benefit format, via access to a global networking system such as the Internet, thereby avoiding the above-discussed disadvantages.

### BRIEF SUMMARY OF THE INVENTION

Briefly described, in the preferred embodiment, the present invention overcomes the above-mentioned disadvantages and meets the recognized need for such a system and method by providing a personal pension comprising a planning process suitable for use as a primary planning vehicle for funding future needs, such as retirement, wherein the process is extremely safe for principal contributions and assures behavioral discipline by greatly restricting pre-retirement withdrawals.

According to its major aspects and broadly stated, the present invention is a system and method of managing monetary contributions for a deferred savings objective such as, for exemplary purposes only, funding college, wedding or marriage, retirement, or any other large expense expected to occur years in the future, wherein a consumer makes contributions into the deferred savings system, wherein the process of the deferred savings method is not tied to any particular employer or employment status, wherein principal contributions are guaranteed after a minimum holding period, and wherein pre-event or pre-retirement withdrawals are restricted.

More specifically, the personal pension system and method of the present invention relates to a unique process of financial planning, wherein the steps of the process work together to define a conservative, custom, portable process capable of performing as a vehicle for any substantial deferred need for funds, including retirement benefits. Accordingly, the preferred system and method of the present invention comprises a series of financial events with particular characteristics. First, a customer makes cash equivalent contributions, of varying sizes and on varying dates, to the personal pension system, wherein each such customer contribution, after a minimum holding period, is guaranteed against loss in principal until the earlier of benefit commencement or death.

Following contribution, development of the guaranteed principal ensues, via a guaranteed return until retirement age, or via a guaranteed share of the upside of a more volatile investment return. During the development phase, customer withdrawals are restricted by age and by a minimum holding period, however benefit commencement may vary, wherein published early benefit reduction formulas and late benefit enhancement formulas are utilized.

For the benefit phase, each customer may choose a beneficiary with whom to share a joint and survivor form of an annuity, wherein variations include, but are not limited to: varying percentage of lump sum vs. annuity at benefit commencement, optional pre-retirement value forfeiture in exchange for enhanced return, and unknown vs. fixed returns on contributions, that is, guaranteed share of upside of unknown return vs. guaranteed return.

Throughout the consumer's involvement and/or participation in the personal pension system and method, a global networking system interface provides each such customer with the ability to receive, on demand, current information from a system containing their data, detailing their contribution history, and reporting their future benefit values.

A feature and advantage of the present invention is the ability of such a system and method to encourage advance planning for future funding needs.

Another feature and advantage of the present invention is the ability of such a system and method to provide individual investor/customer independence, wherein access to a global networking system such as the Internet is utilized for monitoring and control.

Another feature and advantage of the present invention is the ability of such a system and method to induce a consumer to plan for retirement.

Yet another feature and advantage of the present invention is the ability of such a system and method to deliver to the participant guaranteed future compensation, at least up to the amount of principal contributions.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a process diagram of a personal pension system and business method, according to the preferred embodiment of the present invention, illustrating the preferred system inter-organization thereof;

FIG. 2 is a process diagram of the preferred personal pension system and method of FIG. 1, showing the preferred system for an individual member account; and

FIG. 3 is a preferred global networking system interface for the preferred personal pension system and method of FIG. 1.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

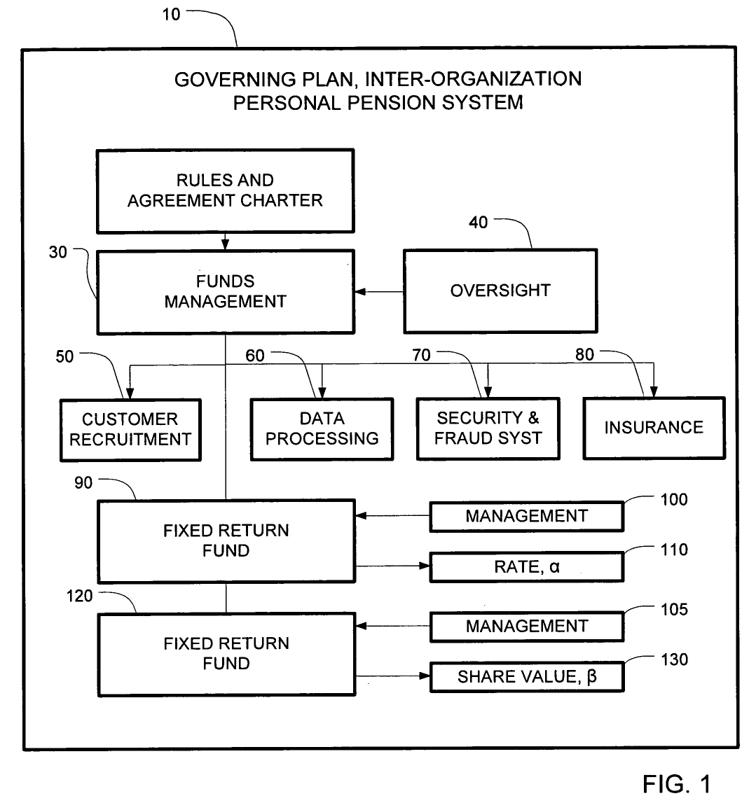

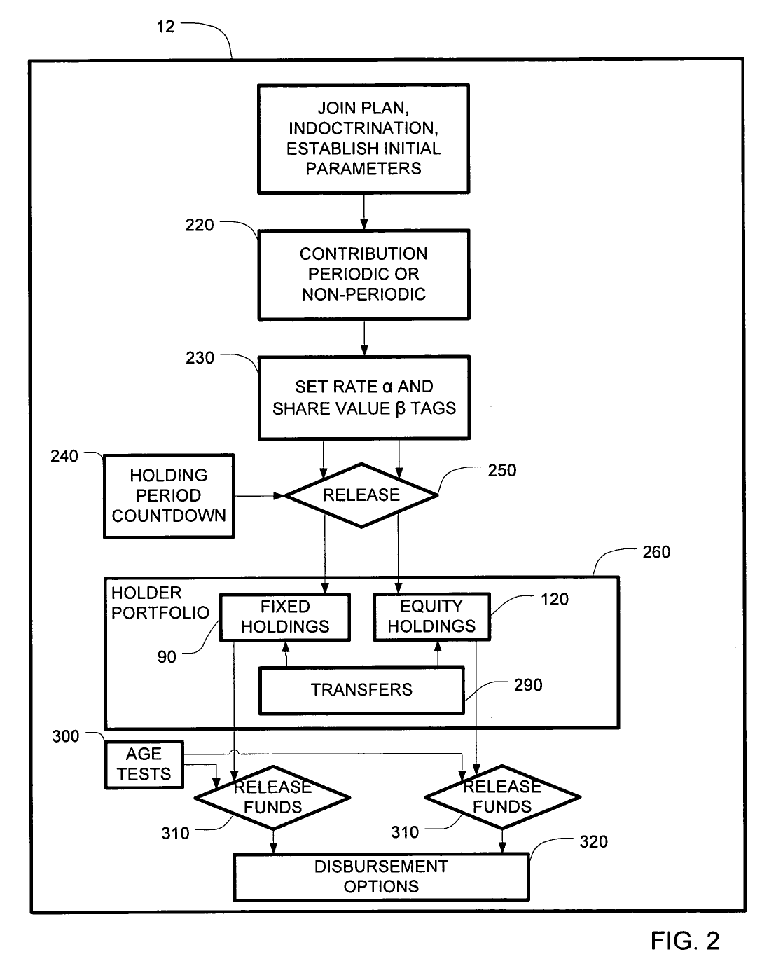

Referring generally to FIGS. 1 and 2, the present invention is a personal pension system and business method 10 comprising an individual retirement plan (IRP) 12 that functions as a private pension plan, preferably funded with individual contributions 220, according to desired terms for rate of return 230 and for disbursement options 320, as selected by the individual. IRP 12 enables an individual to create a stable and predictable financial future, via a series of steps working together to form define a conservative, custom, and portable retirement planning process, suitable for utilization as a primary planning vehicle for any substantial deferred need for funds.

IRP 12 simplifies the long-term investing process, removing complexities that can confuse and inhibit some individuals from planning and participating. For example, an IRP consumer manages retirement age assets instead of current age assets, thereby requiring minimal math skills to plan for a target asset value for a future date. Also, an IRP consumer preferably manages after-tax contributions, realizing tax deferred earnings. One skilled in the art would recognize that an IRP consumer could also manage tax-deferred and/or tax exempt contributions, wherein contributions are for 401(k) and other qualified retirement accounts, either in combination with or in lieu of after-tax contributions. Nonetheless, the IRP supports virtually unlimited contributions, so that each participant can optimize his or her financial future based on available resources.

Preferably, contributions 220 may be in any amount, and preferably at any frequency, periodic or non-periodic, wherein contributions 220 are preferably determined based upon income, savings goals, and/or estimated future financial needs. Thus, IRP 12 removes asset allocation demands from the lay investor, shifting focus to items within their control, such as contribution amounts and frequency, as well as benefit commencement date. To overcome potential individual self-discipline issues introduced via the inherent freedom and nature of IRP 12, there are no loan provisions and early withdrawal fees preferably apply, thereby assisting participants in sticking to their plan. If, however, IRP 12 exists within a 401(k) or other qualified plan, the loan provisions will be those governing all components of the plan.

That is, individual withdrawals are preferably sharply restricted, wherein funds are subjected to minimum holding period 240, and wherein early withdrawal of benefits prior to a predefined date, or age, results in a penalty. In the event of hardship, however, an individual may withdraw contributed funds according to a release process 250, with 90 days notice, wherein the preferred consequence for early withdrawal of contributed funds within the first two years after initial contribution is a 20% early withdrawal fee, and for early withdrawal within the third through fifth year after initial contribution is a 10% early withdrawal fee. It is specifically noted that although the above-referenced withdrawal fees are preferred, alternate percentages and time periods could be utilized, as long as the general concept of withdrawal fees that decline over a given period of time is maintained thereby.

Thus, it is preferred that there will be declining withdrawal fees over the early years following the initial contribution. After five years elapses following initial contribution, withdrawal penalties are dictated by age tests 300, wherein an individual under age 55 will not have withdrawn contributions reduced by a withdrawal fee; further, only after age 55, and after the preferred minimum holding period 240, preferably at least three years from initial contribution date, may total contributions be withdrawn without penalty and with benefit of earnings to date, according to final release process 310. Preferably, individuals may select from a plurality of benefit distribution formats 320, such as, for exemplary purposes only, varying percentage of lump sum vs. annuity at benefit commencement, optional pre-retirement value forfeiture (in exchange for enhanced return) and unknown vs. fixed returns on contributions (guaranteed share of upside of unknown return vs. guaranteed return).

In addition to the beneficial and easily workable investment options, IRP 12 is also beneficially employer independent. Thus, contributions are essentially accepted without restriction except when limits in a qualified retirement plan govern the IRP 12 component. For example, an individual may contribute irrespective of employer, frequency of job change, during periods of non-employment, and if self-employed. Additionally, IRP 12 is relationship independent. Thus, beneficiary designations are essentially accepted without restriction, wherein there is no legal relationship requirement between participant and beneficiary. For example, an individual may preferably designate any beneficiary that laws allow, including non-spousal beneficiaries, wherein spousal consent will be sought only when legally required. Benefits conveyed to the beneficiary preferably vary depending upon the age of the individual benefactor at death, and upon the type and status of the benefit investment.

Preferably, if a participant dies before age 55 and before benefits have commenced, the designated beneficiary will receive the total contributed amount, without interest, preferably 90 days after formal notification of death. If a participant dies after age 55, the designated beneficiary will receive the total contributed amount, with interest, preferably 90 days after formal notification of death. If a participant dies after benefits have commenced, and the benefit being received is a joint and survivor annuity, the annuity will preferably continue based on the terms of the joint and survivor benefit. If a participant dies while receiving a life-only annuity benefit, no beneficiary distribution is provided.

Another unique feature is that IRP 12 is retirement independent. Thus, benefits can begin upon arrival of a predetermined benefit commencement date, as early as age 55. For example, an individual can begin receiving benefits before actual retirement. However, the longer funds remain in IRP 12, the larger the retirement benefit may become. That is, just as early benefit commencement is preferably offered with published early benefit reduction formulas, late benefit commencement is preferably rewarded with published late benefit enhancement formulas.

Further, IRP 12 is government independent. Thus, unlike a traditional corporate pension plan, wherein the federal government insures the benefit (up to a stated maximum yearly benefit), if the IRP is insured, it will be insured by funds in an insurance trust 80 that is not dependent on government guarantee. Instead, all contributions are guaranteed by insurance trust 80 up to a published maximum per person.

Coupled with the individual and independently portable nature of IRP 12 coexists the benefits of large group programs. For example, group annuity purchases preferably enhance the conversion rates. Preferably, at the beginning of each calendar year, a rate will be published for contributions received that year. The rate initially received will preferably continue to be utilized for the quantity of contributions received that year, until the participant receives benefit from that contribution. Thus, funds preferably include fixed return fund 90 with independent manager function 100 and daily rate of return parameter 110, α, and equity/growth investment fund 120 with independent manager function 105 and daily share value 130, β, for evaluations of equity fund shares. Depending upon the individual preferences selected by the participant during selection process 210, until the customer reaches their benefit commencement date, each customer contribution will earn guaranteed return 110, α, and/or will earn guaranteed share 105, β, of the upside of a more volatile investment return. Irrespective of the selected type(s) of return, the principal contribution of each participant preferably remains guaranteed.

Preferably, contributions 20 are placed into IRP investment funds that are professionally managed 30 and held in a trust 40, similar to the way funds are held in a traditional defined benefit pension plan. However, unlike most presently available retirement savings vehicles, IRP 12 essentially guarantees a return, in the form of guarantee of principal against loss, wherein all customer contributions 220, after minimum holding period 240, are guaranteed against loss in principal until the earlier of benefit commencement or death. IRP contributions 220, if insured, are preferably insured up to a published maximum per individual participant via insurance trust 80, thus greatly exceeding traditional FDIC limits. Preferably, professional asset managers 30 manage IRP 12 assets, wherein customer recruitment 50, data processing 60, security and fraud systems 70, and insurance 80 are preferably sub-functions of the funds management 30 provisions. With respect to insurance 80, firms, preferably with very strong credit ratings, transfer investment risk from individuals to their corporation, and transfer mortality risk from individuals to their corporation, by delivering a life annuity payment stream to each participating individual.

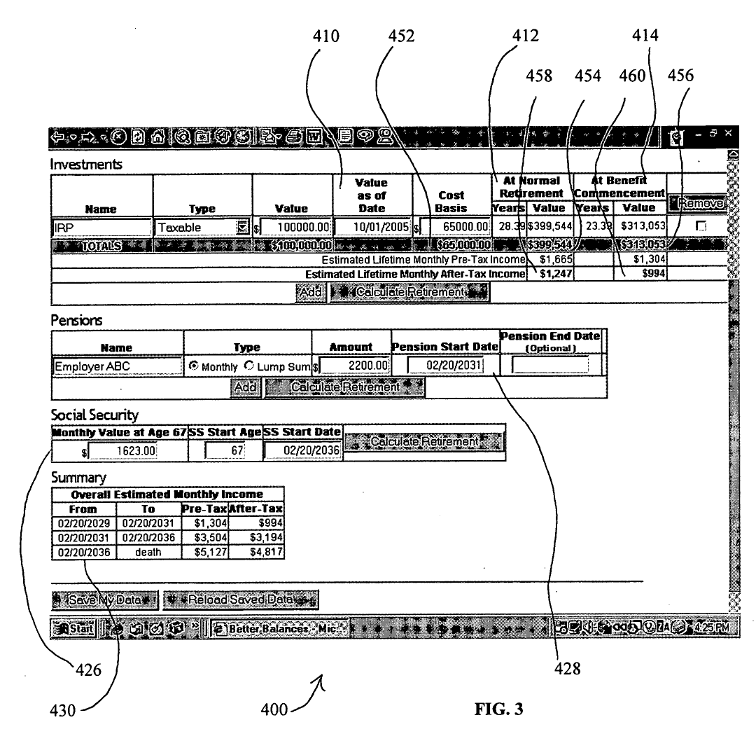

Ongoing individual confidence is ensured because IRP 12 preferably provides consolidated reporting and 7/24 access to data, wherein preferably, technical professionals will direct data management. Referring now to FIG. 3, a preferably web-based IRP management portal 400, accessed via a global networking system, such as the Internet, will preferably enable an individual to manage his or her portfolio 260. That is, preferably, customers will have the ability to receive, on demand, current information via management portal 400, securely containing their data, detailing their contribution history 410 and reporting their future benefit values 412, 414.

Alternately, personal data, such as name, address, beneficiary, customer identification number, and date of birth are accessibly stored for use and editing. One skilled in the art would readily recognize that other and/or additional data could be stored and/or displayed. The preferred data, however, is suitable for planning purposes, wherein, for example, a user can selectively display, based upon his or her personal data, a projected or calculated typical retirement age 426 and/or typical retirement date 428. Alternatively, an individual can select and enter a preferred benefit commencement date 430.

For IRP management purposes, for example, contributions 220 can be listed by date of deposit, amount of deposit, and rate of investment. Based upon individual targets, remaining years to compound (years until benefit ensues) could be calculated and displayed, wherein the benefit at retirement, based upon the guarantee of principal and the applicable rate, is preferably quoted both at a typical retirement age 440 and at the individual's preferred benefit commencement date 442.

For overall financial management purposes, notes and/or special tracking of types of a plurality of investments is supported, such as, for exemplary purposes only, reference to 401k, Treasury bill, and/or personal pension. Preferably, grand totals reported will be total deposits 452 including all such investments, with total benefits reported for both typical retirement age 454 and preferred benefit commencement date 456 for each individual, including an estimated monthly (for life) benefit for each retirement date 458 and 460, pursuant to actual fund values for personal pension and expectation of investment performance for other investments.

In an alternate embodiment, the design elements of personal pension system and business method 10 may also combine to form a corporate offered retirement plan that is funded by an employer rather than individuals, wherein all other aspects could remain, including portability, limited only by the rules governing the employer's retirement plan.

In another alternate embodiment, personal pension system and business method 10 could be offered by an employer, wherein the employer could offer no contribution, could offer some matching or funding, or could fully fund the contribution, wherein all other aspects could remain, including portability.

In another alternate embodiment, personal pension system and business method 10 of the present invention could be adapted for use for any deferred savings objective, including saving for funding college tuition, a wedding, or any other large expense expected to occur years in the future.

In use, the system of preferred personal pension method 10 of the present invention, from the perspective of the individual, begins with the individual joining the plan and establishing initial parameters 210. Preferably, the individual's retirement plan contribution 220 is selected as a continuing periodic series of contributions, or as non-periodic, wherein each is preferably a cash equivalent contribution of a varying size. Also preferably, a rate of return 110, α, is set for fixed income fund 90, and share value 130, β, for equity fund 120 is determined for the individual's contribution. Thereafter, holding period 240 countdown preferably proceeds, following which a release 250 is triggered to move the contribution into the individual's holding portfolio 160.

The preferred portfolio 160 consists of fixed holdings 90 and/or equity holdings 120 accounts for the individual, wherein transfers 290 may preferably be made between account funds. Further, the individual preferably selects from a plurality of options 320 for the disbursement of released funds 310, wherein such withdrawals may only commence, without penalty assessment, after attainment of a specified age and/or holding period.

Having thus described exemplary embodiments of the present invention, it should be noted by those skilled in the art that the disclosures within are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A method of providing a personal pension, comprising the steps of:
a) securing a plurality of individual members, each said member contributing a quantity of funds to a respective individual pension account;
b) permitting each said individual member to select a beneficiary;
c) guaranteeing each said quantity of funds for each said respective individual pension account;
d) professionally managing said quantity of funds;
e) providing a plurality of annuity conversion options for each said individual pension account, wherein disbursement of annuity benefits commences upon attainment of a predetermined date;
f) penalizing each disbursement from each said individual pension account prior to said predetermined date;
g) providing individual access and supervision of each said individual pension account via a global networking system such as the Internet; and
h) enabling portability of each said individual pension account irrespective of employment status of said respective individual contributing member.

2. The method of providing a personal pension of claim 1, wherein said plurality of annuity conversion options comprises a joint and survivor form of an annuity selected from the group of: varying percentage at benefit commencement, lump sum at benefit commencement, pre-retirement value forfeiture in exchange for enhanced return, fixed return on contributions, and/or unknown return with a guaranteed share.

3. The method of providing a personal pension of claim 1, wherein said penalty for each said disbursement from each said individual pension account prior to said predetermined date and within the first two years following said initial contribution to said personal pension is a first percentage early withdrawal fee; wherein said penalty for each said disbursement from each said individual pension account prior to said predetermined date and within the third through fifth year after said initial contribution is a second percentage early withdrawal fee; wherein, after five years elapses following said initial contribution, no penalty is assessed for each said disbursement from each said individual pension account prior to said predetermined date.

4. The method of providing a personal pension of claim 3, wherein penalized and non-penalized disbursements to individuals under age 55 are limited to a maximum amount equal to said principal contribution.

5. The method of providing a personal pension of claim 1, wherein, if said contributing participant dies before age 55 and before benefit distribution has begun, said designated beneficiary receives the total contributed principal; if said contributing participant dies after age 55, said designated beneficiary receives said total contributed principal with earnings; and if said contributing participant dies after benefits have begun and said benefit is a joint and survivor annuity, said annuity will continue, as stipulated by the joint and survivor annuity.

6. The method of providing a personal pension of claim 1, wherein said guarantee of each said quantity of funds for each said respective individual pension account is backed by an insurance trust, wherein each said quantity of funds guaranteed is limited to a published maximum.

7. A real-time, individual financial planning process with employer independence, comprising the steps of:
a) creating a secure portal accessible by participants via a global networking system;
b) enabling said participants to dictate individual fund contribution amounts via said portal;
c) enabling said participants to dictate individual fund contribution dates via said portal;
d) enabling said participants to control commencement date for initiation of return of benefits from said fund contribution via said portal; and
e) enabling said participants to control the format of return of benefits from said fund contribution via said portal.

8. The personal pension system and method of claim 7, wherein said funds managed via said portal are future valued assets.

9. A personal pension system and method, comprising the steps of:
a) making a plurality of cash equivalent contributions, wherein each said contribution, after a minimum holding period, is guaranteed against loss in principal until the earlier of a benefit commencement or death;
b) allowing financial development of a selected portion of said guaranteed principal via a guaranteed return;
c) allowing financial development of a selected portion of said guaranteed principal via a guaranteed share of a non-guaranteed investment return;
d) restricting withdrawals of said guaranteed principal during a minimum holding period;
e) penalizing withdrawals of said guaranteed principal until a preselected age is attained by the personal account contributor;
f) distributing said personal pension upon attainment of a preselected age.

10. The personal pension system and method of claim 9, wherein said penalized withdrawals are subjected to an early benefit reduction formula.

11. The personal pension system and method of claim 9, wherein commencement of said distribution of said personal pension at a date subsequent to the date of attainment of said preselected age results in said distribution being subjected to a late benefit enhancement formula.

12. The personal pension system and method of claim 9, wherein said cash equivalent contributions are after-tax contributions.

13. The personal pension system and method of claim 9, wherein said guaranteed return is set annually and said selected portion contributed during said relevant calendar period shall receive said guaranteed return for the duration of said development period.

14. The personal pension system and method of claim 9, wherein said guaranteed share is set annually and said selected portion contributed during said relevant calendar period shall receive said guaranteed share for the duration of said development period, irrespective of the performance.

15. The real-time, individual financial planning process with employer independence of claim 7, wherein said portal displays personal data, contribution history and future benefit values.

16. The real-time, individual financial planning process with employer independence of claim 7, wherein said portal displays and analyzes a plurality of investment vehicles.

17. The personal pension system and method of claim 9, wherein at least one employer contributes at least a portion of said cash equivalent contribution.

18. The method of providing a personal pension of claim 3, wherein said first percentage withdrawal penalty is 20% and wherein said second percentage withdrawal penalty is 10%.

19. The method of providing a personal pension of claim 6, wherein said published maximum is $20,000,000.00.

20. An individual financial planning process with employer independence, comprising the steps of:
a) creating a secure portal accessible by participants via a global networking system;
b) enabling said participants to track individual fund contribution amounts via said portal;
c) enabling said participants to track individual fund contribution dates via said portal;
d) enabling said participants to track commencement date for initiation of return of benefits from said fund contribution via said portal; and
e) enabling said participants to track the format of return of benefits from said fund contribution via said portal.

21. The personal pension system and method of claim 9, wherein said cash equivalent contributions are tax-deferred contributions.

22. The personal pension system and method of claim 9, wherein said cash equivalent contributions are tax exempt contributions.
